(19) United States
(12) Patent Application Publication
(10) Pub. No.: US 2025/0106886 A1
(43) Pub. Date: Mar. 27, 2025

(54) INFORMATION TRANSMISSION METHOD AND APPARATUS, AND DEVICE AND STORAGE MEDIUM

(71) Applicant: Beijing Xiaomi Mobile Software Co., Ltd., Beijing (CN)

(72) Inventors: Wensu ZHAO, Beijing (CN); Qun ZHAO, Beijing (CN)

(21) Appl. No.: 18/730,887

(22) PCT Filed: Jan. 28, 2022
(86) PCT No.: PCT/CN2022/074824

§ 371 Date: Jul. 22, 2024

(51) Int. Cl. H04W 72/563; H04L 1/1812; H04W 72/0446; H04W 72/40

(52) U.S. Cl. CPC H04W 72/563; H04L 1/1812; H04W 72/0446; H04W 72/40

(57) ABSTRACT

An information transmission method is performed by a first terminal. The method includes: performing a comparison of priorities of first transmission information, second transmission information and third transmission information in a case that a time-domain resource of the first transmission information, a time-domain resource of the second transmission information and a time-domain resource of the third transmission information are overlapped; and transmitting, based on the comparison, one with a highest priority among the first transmission information, the second transmission information and the third transmission information; wherein the first transmission information and the second transmission information are both carried on a physical sidelink feedback channel (PSFCH), and the third transmission information is transmission information other than transmission information carried on the PSFCH.

### CROSS REFERENCE TO RELATED APPLICATIONS

This application is the U.S. national phase application of International Application No. PCT/CN2022/074824, filed on Jan. 28, 2022, the disclosure of which is incorporated herein by reference in its entirety.

### TECHNICAL FIELD

The present disclosure relates to the field of mobile communications, and in particular, to an information transmission method and apparatus, and a device and a storage medium.

### BACKGROUND

In mobile communication technologies, two terminals may communicate with each other, and the terminals may also communicate with a network device. Therefore, for one terminal, the terminal may transmit data with another terminal through a sidelink, and may also transmit data with the network device through an uplink. If the transmission resources corresponding to the sidelink are overlapped with the transmission resources corresponding to the uplink, how the terminal transmits the data becomes an urgent problem to be solved.

### SUMMARY

Examples of the present disclosure provide an information transmission method and apparatus, and a device and a storage medium. The technical solutions are as follows.

According to one aspect of the present disclosure, an information transmission method is provided, performed by a first terminal and including: performing a comparison of priorities of first transmission information, second transmission information and third transmission information in a case that a time-domain resource of the first transmission information, a time-domain resource of the second transmission information and a time-domain resource of the third transmission information are overlapped; and transmitting, based on the comparison, one with a highest priority among the first transmission information, the second transmission information and the third transmission information; wherein the first transmission information and the second transmission information are both carried on a physical sidelink feedback channel (PSFCH), and the third transmission information is transmission information other than transmission information carried on the PSFCH.

According to one aspect of the present disclosure, a terminal is provided, including: a processor; a transceiver connected to the processor; and a memory for storing executable instructions of the processor; wherein the processor is configured to: perform a comparison of priorities of first transmission information, second transmission information and third transmission information in a case that a time-domain resource of the first transmission information, a time-domain resource of the second transmission information and a time-domain resource of the third transmission information are overlapped; and transmit, based on the comparison, one with a highest priority among the first transmission information, the second transmission information and the third transmission information; wherein the first transmission information and the second transmission information are both carried on a physical sidelink feedback channel (PSFCH), and the third transmission information is transmission information other than transmission information carried on the PSFCH.

### BRIEF DESCRIPTION OF THE DRAWINGS

The drawings related to the description of the examples will be briefly introduced to explain the technical solutions provided by examples of the present disclosure more clearly. It is obvious that, the drawings in the following description illustrate only some examples of the present disclosure.

FIG. 1 illustrates a block diagram of a communication system provided by an example of the present disclosure.

FIG. 2 illustrates a flowchart of an information transmission method provided by an example of the present disclosure.

FIG. 3 illustrates a schematic diagram of transmission resources corresponding to information provided by an example of the present disclosure.

FIG. 4 illustrates a flowchart of an information transmission method provided by an example of the present disclosure.

FIG. 5 illustrates a flowchart of an information transmission method provided by an example of the present disclosure.

FIG. 6 illustrates a block diagram of an information transmission apparatus provided by an example of the present disclosure.

FIG. 7 illustrates a block diagram of an information transmission apparatus provided by an example of the present disclosure.

FIG. 8 illustrates a schematic structure diagram of a communication device provided by an example of the present disclosure.

### DETAILED DESCRIPTION OF THE EMBODIMENTS

In order to make the purpose, technical solutions and advantages of the present disclosure clearer, the implementations of the present disclosure will be further described in detail below in conjunction with the accompanying drawings.

Exemplary embodiments will be described in detail herein, examples of which are illustrated in the accompanying drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a,” “the” and “said” in their singular forms used in the examples of the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be adopted in the examples of the present disclosure to describe various information, such information should not be limited to these terms. These terms are only used to distinguish the information of the same type with each other. For example, without departing from the scope of the examples of the present disclosure, first information may be referred as second information; and similarly, second information may also be referred as first information. Depending on the context, the word “if” as used herein may be interpreted as “when,” “upon,” or “in response to determining.”

A scenario where the present disclosure is applied is described below.

FIG. 1 illustrates a block diagram of a communication system provided by an example of the present disclosure. The communication system may include a first terminal 10, a second terminal 20 and a network device 30.

The first terminal 10 and the second terminal 20 may communicate with each other via a sidelink. That is, data may be directly transmitted between the first terminal 10 and the second terminal 20.

In some examples, the second terminal 20 may send sidelink control information (SCI) to the first terminal 10 via a physical sidelink control channel (PSCCH) or a physical sidelink shared channel (PSSCH) to indicate reserved transmission resources. The first terminal 10 determines the transmission resources reserved by the second terminal 20 based on the SCI sent by the second terminal 20. If the first terminal 10 determines that the transmission resources reserved by the second terminal 20 are overlapped with those of another terminal, the first terminal 10 is required to send sidelink potential conflict indication information to the second terminal 20. The second terminal 20 is informed through the sidelink potential conflict indication information that its reserved transmission resources are overlapped with those of another terminal. The second terminal 20 is required to re-determine the transmission resources.

In every cell managed by the network device 30, it allows one or more first terminals 10 or multiple second terminals 20 to be distributed. The first terminal 10 or the second terminal 20 may include various devices with a wireless communication function, like handhold devices, vehicle-mounted devices, wearable devices, computing devices or other processing devices connected to a wireless modem, as well as various forms of user equipment (UE), mobile stations (MS), etc. For the convenience of description, the above-mentioned devices are collectively referred to as terminals in the examples of the present disclosure.

The network device 30 is a type of devices deployed in an access network to provide a wireless communication function for the first terminal 10 and/or the second terminal 20. For the convenience of description, the above-mentioned devices that provide the wireless communication function for the first terminal 10 and/or the second terminal 20 are collectively referred to as network devices. One or more connections may be established between the network device 30 and the first terminal 10 and/or the second terminal 20 via air interface, so that communications are performed via the one or more connections, including interactions of signaling and data. There may be multiple network devices 30. Two adjacent network devices 30 may communicate with each other via wired or wireless means. The first terminal 10 and/or the second terminal 20 may switch between different network devices 30, that is, establish connections with different network devices 30.

The network device 30 may include various forms, like a macro base station, a micro base station, a relay station, an access point, etc. In systems adopting different wireless access technologies, the device with the network device functions may have different names. For example, it is called gNodeB or gNB in 5G NR systems. As communication technologies evolve, the name “network device” may change.

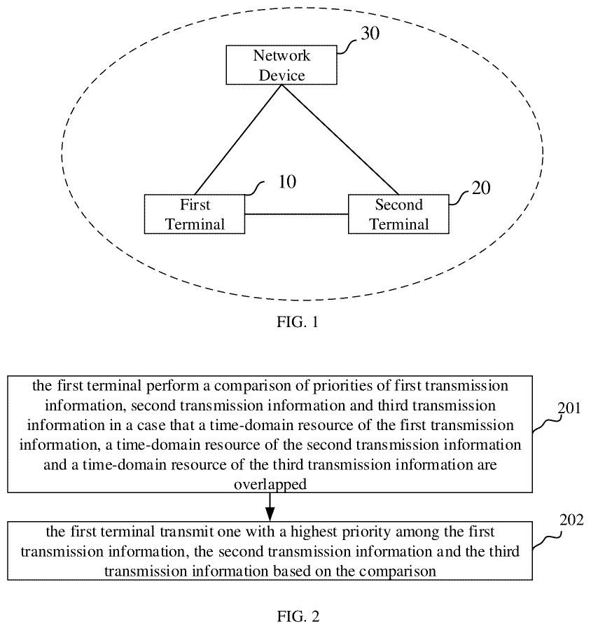

FIG. 2 illustrates a flowchart of an information transmission method provided by an example of the present disclosure, which, for example, may be applied to the first terminal illustrated in FIG. 1. The method includes at least part of the following contents.

At step 201, the first terminal performs a comparison of priorities of first transmission information, second transmission information and third transmission information in a case that a time-domain resource of the first transmission information, a time-domain resource of the second transmission information and a time-domain resource of the third transmission information are overlapped.

The first transmission information and the second transmission information are both carried on a physical sidelink feedback channel (PSFCH), and the third transmission information is transmission information other than the transmission information carried on the PSFCH. That is, the first transmission information and the second transmission information are both transmitted on the PSFCH, and the third transmission information is transmitted in another channel. In some examples, the time-domain resource of the first transmission information and the time-domain resource of the second transmission information are the same. Alternatively, the time-domain resource of the first transmission information and the time-domain resource of the second transmission information are overlapped, but their frequency-domain resources are different.

In the examples of the present disclosure, the first terminal is required to transmit the first transmission information, the second transmission information and the third transmission information. For the first terminal, it has to transmit an excessive amount of information since the time-domain resource of the first transmission information, the time-domain resource of the second transmission information and the time-domain resource of the third transmission information are overlapped, which requires to control a transmission power of the first terminal. Therefore, the first terminal compares the priority of the first transmission information, the priority of the second transmission information and the priority of the third transmission information to distinguish between high-priority and low-priority transmission information.

The case that the time-domain resource of the first transmission information, the time-domain resource of the second transmission information and the time-domain resource of the third transmission information are overlapped means that: the time-domain resource of the first transmission information, the time-domain resource of the second transmission information and the time-domain resource of the third transmission information are the same partly, or the time-domain resource of the first transmission information, the time-domain resource of the second transmission information and the time-domain resource of the third transmission information are the same fully.

In some examples, the priorities of various pieces of information in the present disclosure are represented by priority values. Particularly, the priorities are represented by the priority values, and the priority values are inversely proportional to the priorities. In other words, the greater the priority value corresponding to the information, the lower the priority of the information, and the smaller the priority value corresponding to the information, the higher the priority of the information.

In some examples, the third transmission information may include fourth transmission information carried on an uplink transmission channel and/or long-term evolution technology (LTE) sidelink transmission information.

Particularly, the third transmission information includes the information carried on the uplink transmission channel, or includes the LTE sidelink transmission information, or includes both the fourth transmission information carried on the uplink transmission channel and the LTE sidelink transmission information.

In an example, the LTE sidelink transmission information is carried on an LTE PSCCH or an LTE PSSCH.

It is to be noted that the examples of the present disclosure are only described by taking the first transmission information, the second transmission information and the third transmission information as an instance. In another example, the first transmission information is sidelink potential conflict indication information, which indicates that a transmission resource of a second terminal is overlapped with a transmission resource of another terminal, and the second transmission information is sidelink hybrid automatic repeat request (HARQ) feedback information.

The sidelink potential conflict indication information is sent by assisting UE to assisted UE in an inter-UE assistance mechanism, and indicates that the transmission resource of the second terminal is overlapped with the transmission resource of another terminal. A resource conflict is to occur at future Slot m.

In the inter-UE assistance mechanism of R17, the potential conflict indication is 1 bit, indicating whether there is a potential conflict. The potential conflict indication is sent by the assisting UE to the assisted UE, that is, sent by the first terminal to the second terminal, and is sent on the PSFCH of the first terminal. Through decoding a frequency-domain resource allocation information field and a time-domain resource allocation information field carried in SCI of the second terminal and another terminal, when the first terminal identifies that the second terminal and another terminal have reserved partially/fully overlapped resource at future Slot m, and a reference signal receiving power (RSRP) measurement value of a demodulation reference signal (DMRS) of the SCI for the partially/fully overlapped resource that is reserved by another terminal is greater than a RSRP threshold or greater than the RSRP measurement value of the DMRS of the SCI for the resource reserved by the second terminal, the first terminal determines that there is to be a potential resource conflict on the partially/fully overlapped resource at future Slot m. Therefore, the first terminal sends the potential conflict indication to the second terminal, and the second terminal performs a resource re-selection after receiving the potential conflict indication.

In addition, in the examples of the present disclosure, all first transmission information may be replaced by the sidelink potential conflict indication information, and all second transmission information may be replaced by the sidelink HARQ feedback information.

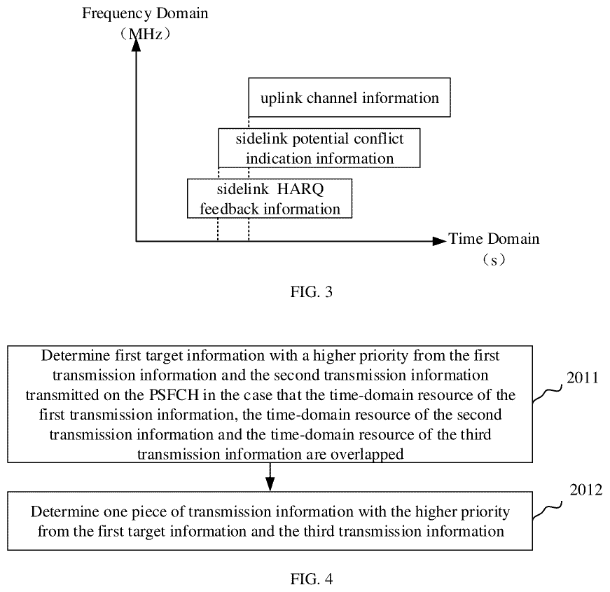

In some examples, taking an instance where the first transmission information is the sidelink potential conflict indication information, the second transmission information is the sidelink HARQ feedback information, and the third transmission information is uplink channel information, FIG. 3 illustrates the time-domain resource of the sidelink potential conflict indication information, the time-domain resource of the sidelink HARQ feedback information and the time-domain resource of the uplink channel information, respectively. Referring to FIG. 3, the frequency-domain resource of the sidelink potential conflict indication information, the frequency-domain resource of the sidelink HARQ feedback information and the frequency-domain resource of the uplink channel information are all different, but the time-domain resource of the sidelink potential conflict indication information, the time-domain resource of the sidelink HARQ feedback information and the time-domain resource of the uplink channel information are overlapped between the dotted lines, which means that the sidelink potential conflict indication information, the sidelink HARQ feedback information and the uplink channel information have overlapped time-domain resources.

At step 202, the first terminal transmits one with a highest priority among the first transmission information, the second transmission information and the third transmission information based on the comparison.

In the examples of the present disclosure, the first terminal may obtain a comparison result after the comparison, and then determine the one with the highest priority among the first transmission information, the second transmission information and the third transmission information based on the comparison result for transmission.

In some examples, the first transmission information includes the first transmission information that is received and the first transmission information that is sent, and the second transmission information includes the second transmission information that is received and the second transmission information that is sent.

In an example of the present disclosure, for the first transmission information and the second transmission information transmitted on the PSFCH, the first transmission information includes the first transmission information that the first terminal is required to receive, and may also include the first transmission information that the first terminal is required to send. In addition, the second transmission information includes the second transmission information that the first terminal is required to receive, and may also include the second transmission information that the first terminal is required to send.

It is to be noted that the examples of the present disclosure are only described by taking the case that the first terminal transmits one piece of transmission information with the highest transmission priority as an instance. In another example, the first terminal may continue to transmit other transmission information.

Alternatively, the first terminal transmits other transmission information that is remaining, in sequence according to the priorities.

In an example of the present disclosure, the first terminal compares the priorities of the first transmission information, the second transmission information and the third transmission information, that is, it may determine the transmission information with decreasing priorities. After transmitting the transmission information with the highest priority, the first terminal may continue to transmit other transmission information with lower priorities.

For example, the priorities determined by the first terminal in a descending order correspond to the first transmission information, the third transmission information and the second transmission information, respectively. Thus, the first terminal transmits the first transmission information, then transmits the third transmission information, and finally transmits the second transmission information.

In some examples, the first terminal transmits one piece of transmission information with the highest priority, and determines whether its own transmission power is still capable of transmitting other transmission information. If it determines that other transmission information is still capable of being transmitted, the first terminal transmits other transmission information that is remaining in sequence according to the priorities.

Alternatively, the first terminal abandons the transmissions of other transmission information that is remaining.

In an example of the present disclosure, the first terminal compares the priorities of the first transmission information, the second transmission information and the third transmission information, that is, it may determine the transmission information with the highest priority. After transmitting the transmission information with the highest priority, the first terminal may no longer transmit other information that is remaining.

In some examples, the first terminal transmits the transmission information with the highest priority. The first terminal determines whether its own transmission power exceeds a preset maximum power value. If the maximum power value is not exceeded, the first terminal is still capable of transmitting other transmission information. If the preset maximum power value is exceeded, that is, it determines that other transmission information is not capable of being transmitted, the first terminal abandons the transmission of other information that is remaining.

In the information transmission method provided by the examples of the present disclosure, since the time-domain resource of the first transmission information required to be transmitted by the first terminal, the time-domain resource of the second transmission information required to be transmitted by the first terminal and the time-domain resource of the third transmission information required to be transmitted by the first terminal are overlapped, the transmission power of the first terminal is to exceed the preset maximum power value if all three types of information are transmitted. Therefore, the first terminal determines the transmission information with the highest priority according to the priorities corresponding respectively to the above information, and then transmits the transmission information, thereby ensuring the transmission of the information with the high priority and further ensuring a communication reliability.

On the basis of the example illustrated in FIG. 2, the first terminal first compares the information transmitted on the same transmission channel, and then compares the information transmitted on different transmission channels, and finally determines the transmission information.

In some examples, in the case that the time-domain resource of the first transmission information, the time-domain resource of the second transmission information and the time-domain resource of the third transmission information are overlapped, the priorities of pieces of information transmitted on the same transmission channel are first compared to determine one piece of transmission information with the higher priority, and the one piece of transmission information with the higher priority is compared with a piece of transmission information transmitted on a different transmission channel.

In an example of the present disclosure, both the first transmission information and the second transmission information are carried on the PSFCH. Therefore, according to the difference between the channels carrying the transmission information, the priorities of pieces of transmission information carried on the same transmission channel may be compared first, and then the priorities of pieces of transmission information carried on different transmission channels may be compared.

Alternatively, FIG. 4 illustrates a flowchart of an information transmission method provided by an example of the present disclosure. Referring to FIG. 4, the information transmission method includes the following steps.

At step 2011, first target information with a higher priority is determined from the first transmission information and the second transmission information transmitted on the PSFCH in the case that the time-domain resource of the first transmission information, the time-domain resource of the second transmission information and the time-domain resource of the third transmission information are overlapped.

In the example of the present disclosure, the first terminal determines that the time-domain resource of the first transmission information, the time-domain resource of the second transmission information and the time-domain resource of the third transmission information are overlapped, and then is required to select the information with the higher priority. Therefore, the first terminal first compares the priority of the first transmission information transmitted on the PSFCH and the priority of the second transmission information transmitted on the PSFCH, and selects the first target information with the higher priority from the two pieces of information.

For example, the priorities of the information are represented by the priority values, the priority value corresponding to the first transmission information is 4, and the priority value corresponding to the second transmission information is 3. Thus, the first target information with the higher priority selected from the first transmission information and the second transmission information is the second transmission information.

At step 2012, one piece of transmission information with the higher priority is determined from the first target information and the third transmission information.

In the example of the present disclosure, after selecting the first target information with the high priority, the first terminal compares the priority of the first target information with the priority of the third transmission information, and selects the transmission information with the highest priority from the first target information and the third transmission information.

For example, the priorities of the information are represented by the priority values, the priority value corresponding to the third transmission information is 0. Thus, the transmission information with the highest priority selected from the first target information and the third transmission information is the third transmission information.

In a solution provided by an example of the present disclosure, the terminal first compares the first transmission information and the second transmission information transmitted on the PSFCH to select the first target information with the higher priority, and then compares the first target information and the third transmission information to determine the transmission information with the highest priority, thereby ensuring the accuracy of the determined transmission information and further ensuring the reliability of transmitting the information with the highest priority.

It is to be noted that the third transmission information in the examples of the present disclosure may further include two types of information, namely fourth transmission information carried on the uplink transmission channel and LTE sidelink transmission information, respectively. That is, the time-domain resource of the first transmission information, the time-domain resource of the second transmission information, the time-domain resource of the fourth transmission information and the time-domain resource of the LTE sidelink transmission information are overlapped. The information transmission method in the examples of the present disclosure is described below.

In some examples, in the case that the time-domain resource of the first transmission information, the time-domain resource of the second transmission information, the time-domain resource of the fourth transmission information and the time-domain resource of the LTE sidelink transmission information are overlapped, second target information with the higher priority is determined from the pieces of information transmitted on the same transmission channel, and the transmission information with the highest priority is determined from the second target information and a piece of transmission information transmitted on a different transmission channel.

In one possible implementation, in the case that the time-domain resource of the first transmission information, the time-domain resource of the second transmission information, the time-domain resource of the fourth transmission information and the time-domain resource of the LTE sidelink transmission information are overlapped, the priorities of the first transmission information and the second transmission information transmitted on the same transmission channel are first compared to determine one piece of transmission information with a high priority, the one piece of transmission information with the high priority is compared with the fourth transmission information to determine one piece of transmission information with the higher priority, and then the determined one piece of transmission information with the higher priority is compared with the LTE sidelink transmission information to determine the one with the highest priority.

In another possible implementation, in the case that the time-domain resource of the first transmission information, the time-domain resource of the second transmission information, the time-domain resource of the fourth transmission information and the time-domain resource of the LTE sidelink transmission information are overlapped, the priorities of the first transmission information and the second transmission information transmitted on the same transmission channel are first compared to determine one piece of transmission information with a high priority, the one piece of transmission information with the high priority is compared with the LTE sidelink transmission information to determine one piece of transmission information with the higher priority, and then the determined one piece of transmission information with the higher priority is compared with the fourth transmission information to determine the one with the highest priority.

Alternatively, FIG. 5 illustrates a flowchart of an information transmission method provided by an example of the present disclosure. Referring to FIG. 5, the information transmission method includes the following steps.

At step 501, second target information with the high priority is determined from the first transmission information and the second transmission information transmitted on the PSFCH in the case that the time-domain resource of the first transmission information, the time-domain resource of the second transmission information, the time-domain resource of the fourth transmission information and the time-domain resource of the LTE sidelink transmission information are overlapped.

In the example of the present disclosure, the first terminal determines that the time-domain resource of the first transmission information, the time-domain resource of the second transmission information, the time-domain resource of the fourth transmission information and the time-domain resource of the LTE sidelink transmission information are overlapped, and then is required to select the information with the higher priority. Therefore, the first terminal first compares the priority of the first transmission information transmitted on the PSFCH and the priority of the second transmission information transmitted on the PSFCH, and selects the second target information with the high priority from the two pieces of information.

For example, the priorities of the information are represented by the priority values, the priority value corresponding to the first transmission information is 4, and the priority value corresponding to the second transmission information is 3. Thus, the second target information with the high priority selected from the first transmission information and the second transmission information is the second transmission information.

At step 502, third target information with the higher priority is determined from the second target information and the fourth transmission information, and one piece of transmission information with the highest priority is determined from the third target information and the LTE sidelink transmission information.

In the example of the present disclosure, after determining the second target information, the first terminal compares the priority of the second target information with the priority of the fourth transmission information, determines the third target information with the higher priority from the second target information and the fourth transmission information, then compares the priority of the third target information with the priority of the LTE sidelink transmission information, and determines one piece of transmission information with the highest priority from the third target information and the LTE sidelink transmission information.

For example, the priorities of information are represented by the priority values, the priority value corresponding to the fourth transmission information is 0, and the priority value corresponding to the LTE sidelink transmission information is 5. Thus, the third target information selected from the second target information and the fourth transmission information is the fourth transmission information, and the transmission information with the highest priority selected from the third target information and the LTE sidelink transmission information is the fourth transmission information.

In the solution provided by the example of the present disclosure, the terminal first compares the first transmission information and the second transmission information transmitted on the PSFCH to select the second target information with the high priority, then compares the second target information and the fourth transmission information to select the third target information, and finally compares the third target information and the LTE sidelink transmission information to determine the transmission information with the highest priority, thereby ensuring the accuracy of the determined transmission information and further ensuring the reliability of transmitting the information with the highest priority.

It is to be noted that the example of the present disclosure is only described by taking step 502 as an instance. In another example, it may not perform step 502, but determine fourth target information with a higher priority from the second target information and the LTE sidelink transmission information, and determines the transmission information with the highest priority from the fourth target information and the fourth transmission information.

In the example of the present disclosure, after determining the second target information, the first terminal compares the priority of the second target information with the priority of the LTE sidelink transmission information, determines the third target information with the higher priority from the second target information and the LTE sidelink transmission information, then compares the priority of the third target information with the priority of the fourth transmission information, and determines the transmission information with the highest priority from the third target information and the fourth transmission information.

For example, the priorities of information are represented by the priority values, the priority value corresponding to the fourth transmission information is 0, and the priority value corresponding to the LTE sidelink transmission information is 5. Thus, the third target information selected from the second target information and the LTE sidelink transmission information is the second transmission information, and the transmission information with the highest priority selected from the third target information and the fourth transmission information is the fourth transmission information.

In the solution provided by the example of the present disclosure, the terminal first compares the first transmission information and the second transmission information transmitted on the PSFCH to select the second target information with the high priority, then compares the second target information and the LTE sidelink transmission information to select the third target information, and finally compares the third target information and the fourth transmission information to determine the transmission information with the highest priority, thereby ensuring the accuracy of the determined transmission information and further ensuring the reliability of transmitting the information with the highest priority.

On the basis of the example illustrated in FIG. 2, the first terminal may compare the priorities of the three types of information simultaneously, and then determine the transmission information with the highest priority.

In some examples, in the case that the time-domain resource of the first transmission information, the time-domain resource of the second transmission information and the time-domain resource of the third transmission information are overlapped, the first transmission information, the second transmission information and the third transmission information are sorted according to the priorities, and based on the sorting, the one with the highest priority among the first transmission information, the second transmission information and the third transmission information is transmitted.

In an example, the priorities of the information are represented by the priority values. And, the priority value corresponding to the first transmission information is 4, the priority value corresponding to the second transmission information is 3, and the priority value corresponding to the third transmission information is 0. Thus, the first transmission information, the second transmission information and the third transmission information are sorted in order of descending priorities, that is in fact, they are sorted in order of ascending priority values. The sorted sequence is the third transmission information, the second transmission information and the first transmission information. Therefore, the obtained transmission information with the highest priority is the third transmission information.

In an example, the priorities of the information are represented by the priority values. And, the priority value corresponding to the first transmission information is 4, the priority value corresponding to the second transmission information is 3, and the priority value corresponding to the third transmission information is 0. Thus, the first transmission information, the second transmission information and the third transmission information are sorted in order of ascending priorities, that is in fact, they are sorted in order of descending priority values. The sorted sequence is the first transmission information, the second transmission information and the third transmission information. Therefore, the obtained transmission information with the highest priority is the third transmission information.

In the solutions provided by the examples of the present disclosure, the first transmission information, the second transmission information and the third transmission information are sorted in order of ascending or descending priorities. After obtaining the sorted sequence, the transmission information with the highest priority may be determined, thereby ensuring the accuracy of the determined transmission information and further ensuring the reliability of transmitting the information with the highest priority.

It is to be noted that the third transmission information in the examples of the present disclosure may further include two types of information, namely fourth transmission information carried on the uplink transmission channel and LTE sidelink transmission information, respectively. That is, the time-domain resource of the first transmission information, the time-domain resource of the second transmission information, the time-domain resource of the fourth transmission information and the time-domain resource of the LTE sidelink transmission information are overlapped. The information transmission method in an example of the present disclosure is described below.

In some examples, in the case that the time-domain resource of the first transmission information, the time-domain resource of the second transmission information, the time-domain resource of the fourth transmission information and the time-domain resource of the LTE sidelink transmission information are overlapped, the first transmission information, the second transmission information, the fourth transmission information and the LTE sidelink transmission information are sorted in order of descending priorities, and the transmission information with the highest priority is determined according to the sorted sequence.

For example, the priorities of information are represented by the priority values. And, the priority value corresponding to the first transmission information is 4, the priority value corresponding to the second transmission information is 3, the priority value corresponding to the fourth transmission information is 0, and the priority value corresponding to the LTE sidelink transmission information is 5. Thus, the first transmission information, the second transmission information, the fourth transmission information and the LTE sidelink transmission information are sorted in order of descending priorities, that is in fact, they are sorted in order of ascending priority values. The sorted sequence is the fourth transmission information, the second transmission information, the first transmission information and the LTE sidelink transmission information. Therefore, the obtained transmission information with the highest priority is the fourth transmission information.

In some other examples, in the case that the time-domain resource of the first transmission information, the time-domain resource of the second transmission information, the time-domain resource of the fourth transmission information and the time-domain resource of the LTE sidelink transmission information are overlapped, the first transmission information, the second transmission information, the fourth transmission information and the LTE sidelink transmission information are sorted in order of ascending priorities, and the transmission information with the highest priority is determined according to the sorted sequence.

For example, the priorities of information are represented by the priority values. And, the priority value corresponding to the first transmission information is 4, the priority value corresponding to the second transmission information is 3, the priority value corresponding to the fourth transmission information is 0, and the priority value corresponding to the LTE sidelink transmission information is 5. Thus, the first transmission information, the second transmission information, the fourth transmission information and the LTE sidelink transmission information are sorted in order of ascending priorities, that is in fact, they are sorted in order of descending priority values. The sorted sequence is the LTE sidelink transmission information, the first transmission information, the second transmission information and the fourth transmission information. Therefore, the obtained transmission information with the highest priority is the fourth transmission information.

In the solutions provided by the examples of the present disclosure, the first transmission information, the second transmission information, the fourth transmission information and the LTE sidelink transmission information are sorted in order of ascending or descending priorities. After obtaining the sorted sequence, the transmission information with the highest priority may be determined, thereby ensuring the accuracy of the determined transmission information and further ensuring the reliability of transmitting the information with the highest priority.

On the basis of the example illustrated in FIG. 2, the first terminal may compare the priorities of the first transmission information, the second transmission information and the third transmission information in a predetermined sequence in the case that the time-domain resource of the first transmission information, the time-domain resource of the second transmission information and the time-domain resource of the third transmission information are overlapped.

In an example, the predetermined sequence is the first transmission information, the third transmission information and the second transmission information. Thus, in the case that the time-domain resource of the first transmission information, the time-domain resource of the second transmission information and the time-domain resource of the third transmission information are overlapped, fifth target information with the higher priority is determined from the first transmission information and the third transmission information, and one piece of transmission information with the highest priority is determined from the fifth target information and the second transmission information.

For example, the priorities of information are represented by the priority values. And, the priority value corresponding to the first transmission information is 4, the priority value corresponding to the second transmission information is 3, and the priority value corresponding to the third transmission information is 0. Thus, the priority of the first transmission information and the priority of the third transmission information are first compared to determine the third transmission information as the fifth target information with the higher priority, and then the priority of the fifth target information and the priority of the second transmission information are compared to determine the third transmission information as the transmission information with the highest priority.

In an example, the predetermined sequence is the second transmission information, the third transmission information and the first transmission information. Thus, in the case that the time-domain resource of the first transmission information, the time-domain resource of the second transmission information and the time-domain resource of the third transmission information are overlapped, sixth target information with the higher priority is determined from the second transmission information and the third transmission information, and one piece of transmission information with the highest priority is determined from the sixth target information and the first transmission information.

For example, the priorities of information are represented by the priority values. And, the priority value corresponding to the first transmission information is 4, the priority value corresponding to the second transmission information is 3, and the priority value corresponding to the third transmission information is 0. Thus, the priority of the second transmission information and the priority of the third transmission information are first compared to determine the uplink indication information as the sixth target information with the higher priority, and then the priority of the sixth target information and the priority of the first transmission information are compared to determine the third transmission information as the transmission information with the highest priority.

In the solutions provided by the examples of the present disclosure, the priorities of the first transmission information, the second transmission information and the third transmission information are compared in the predetermined sequence to obtain the transmission information with the highest priority, thereby ensuring the accuracy of the determined transmission information, further ensuring the reliability of transmitting the information with the highest priority, as well as reducing the calculation amount of the first terminal and saving the energy consumption of the first terminal.

It is to be noted that the third transmission information in the examples of the present disclosure may further include two types of information, namely fourth transmission information carried on the uplink transmission channel and LTE sidelink transmission information, respectively. That is, the time-domain resource of the first transmission information, the time-domain resource of the second transmission information, the time-domain resource of the fourth transmission information and the time-domain resource of the LTE sidelink transmission information are overlapped. The information transmission method in an example of the present disclosure is described below.

In an example, the predetermined sequence is the first transmission information, the LTE sidelink transmission information, the second transmission information and the fourth transmission information. Thus, in the case that the time-domain resource of the first transmission information, the time-domain resource of the second transmission information, the time-domain resource of the fourth transmission information and the time-domain resource of the LTE sidelink transmission information are overlapped, seventh target information with the high priority is determined from the first transmission information and the LTE sidelink transmission information, eighth transmission information with the higher priority is determined from the seventh target information and the second transmission information, and one piece of transmission information with the highest priority is determined from the eighth target information and the fourth transmission information.

For example, the priorities of information are represented by the priority values. And, the priority value corresponding to the first transmission information is 4, the priority value corresponding to the second transmission information is 3, the priority value corresponding to the fourth transmission information is 0, and the priority value corresponding to the LTE sidelink transmission information is 5. Thus, the priority of the first transmission information and the priority of the LTE sidelink transmission information are first compared to determine the first transmission information as the seventh target information with the high priority, then the priority of the seventh target information and the priority of the second transmission information are compared to determine the second transmission information as the eighth target information with the higher priority, and finally the priority of the eighth target information and the priority of the fourth transmission information are compared to determine the fourth transmission information as the transmission information with the highest priority.

In an example, the predetermined sequence is the second transmission information, the LTE sidelink transmission information, the first transmission information and the fourth transmission information. Thus, in the case that the time-domain resource of the first transmission information, the time-domain resource of the second transmission information, the time-domain resource of the fourth transmission information and the time-domain resource of the LTE sidelink transmission information are overlapped, ninth target information with the high priority is determined from the second transmission information and the LTE sidelink transmission information, tenth transmission information with the higher priority is determined from the ninth target information and the first transmission information, and one piece of transmission information with the highest priority is determined from the ninth target information and the fourth transmission information.

For example, the priorities of information are represented by the priority values. And, the priority value corresponding to the first transmission information is 4, the priority value corresponding to the second transmission information is 3, the priority value corresponding to the fourth transmission information is 0, and the priority value corresponding to the LTE sidelink transmission information is 5. Thus, the priority of the second transmission information and the priority of the LTE sidelink transmission information are compared first to determine the second transmission information as the ninth target information with the high priority, then the priority of the ninth target information and the priority of the first transmission information are compared to determine the second transmission information as the tenth target information with the higher priority, and finally the priority of the tenth target information and the priority of the fourth transmission information are compared to determine the fourth transmission information as the transmission information with the highest priority.

In the solutions provided by the examples of the present disclosure, the priorities of the first transmission information, the second transmission information, the fourth transmission information and the LTE sidelink transmission information are compared in the predetermined sequence to obtain the transmission information with the highest priority, thereby ensuring the accuracy of the determined transmission information, further ensuring the reliability of transmitting the information with the highest priority, as well as reducing the calculation amount of the first terminal and saving the energy consumption of the first terminal.

It is to be noted that the above-mentioned examples may be divided into new examples, or combined with other examples to form new examples. This present disclosure does not limit the combinations of the examples.

In the information transmission method provided by the examples of the present disclosure, since the time-domain resource of the first transmission information required to be transmitted by the first terminal, the time-domain resource of the second transmission information required to be transmitted by the first terminal and the time-domain resource of the third transmission information required to be transmitted by the first terminal are overlapped, a transmission power of the first terminal is to exceed a maximum power value if all three types of information are transmitted. The first terminal determines the transmission information with a highest priority according to the priorities corresponding respectively to the above information, and then transmits the transmission information with the highest priority, thereby ensuring the transmission of the information with the highest priority and further ensuring a communication reliability.

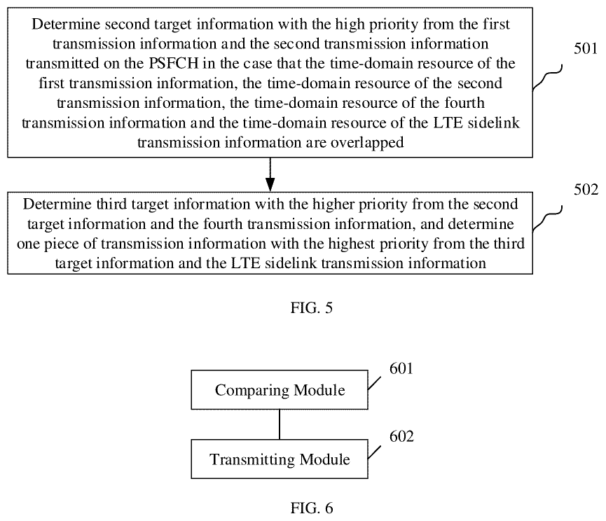

FIG. 6 illustrates a block diagram of an information transmission apparatus provided by an example of the present disclosure. Referring to FIG. 6, the apparatus includes:
a comparing module 601, configured to perform a comparison of priorities of first transmission information, second transmission information and third transmission information in a case that a time-domain resource of the first transmission information, a time-domain resource of the second transmission information and a time-domain resource of the third transmission information are overlapped; and
a transmitting module 602, configured to transmit, based on a comparison result obtained from the comparison, one with a highest priority among the first transmission information, the second transmission information and the third transmission information.

The first transmission information and the second transmission information are both carried on a PSFCH, and the third transmission information is transmission information other than the transmission information carried on the PSFCH.

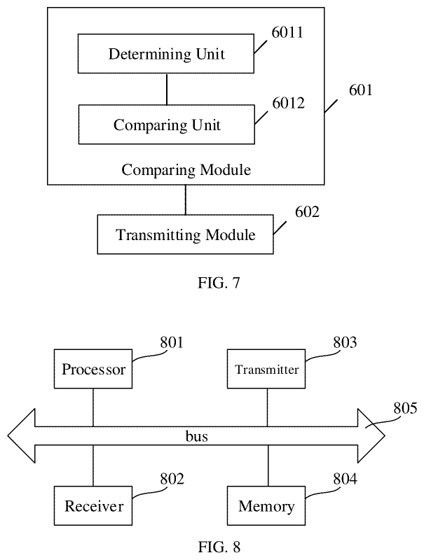

In some examples, referring to FIG. 7, the comparing module 601 includes:
a determining unit 6011, configured to compare the priorities of pieces of information transmitted on a same transmission channel firstly to determine one piece of transmission information with a higher priority in the case that the time-domain resource of the first transmission information, the time-domain resource of the second transmission information and the time-domain resource of the third transmission information are overlapped; and
a comparing unit 6012, configured to compare the one piece of transmission information with the higher priority with apiece of transmission information transmitted on a different transmission channel.

In some examples, referring to FIG. 7, the comparing module 601 includes:
a determining unit 6011, configured to compare the priorities of the first transmission information and the second transmission information transmitted on the PSFCH to determine one piece of transmission information with a higher priority in the case that the time-domain resource of the first transmission information, the time-domain resource of the second transmission information and the time-domain resource of the third transmission information are overlapped; and
a comparing unit 6012, configured to compare the one piece of transmission information with the higher priority with the third transmission information.

In some examples, the comparing module 601 is further configured to sort the first transmission information, the second transmission information and the third transmission information according to the priorities in the case that the time-domain resource of the first transmission information, the time-domain resource of the second transmission information and the time-domain resource of the third transmission information are overlapped.

The transmitting module 602 is further configured to transmit, based on the sorting, the one with the highest priority among the first transmission information, the second transmission information and the third transmission information.

In some examples, the comparing module 601 is further configured to perform a comparison of the priorities of the first transmission information, the second transmission information and the third transmission information in a predetermined sequence in the case that the time-domain resource of the first transmission information, the time-domain resource of the second transmission information and the time-domain resource of the third transmission information are overlapped.

In some examples, the transmitting module 602 is further configured to transmit other transmission information that is remaining in sequence according to the priorities.

In some examples, the transmitting module 602 is further configured to abandon transmission of other transmission information that is remaining.

In some examples, the third transmission information includes fourth transmission information carried on an uplink transmission channel and/or LTE sidelink transmission information.

In some examples, the first transmission information includes the first transmission information that is received by a first terminal and the first transmission information that is sent by the first terminal, and the second transmission information includes the second transmission information that is received by the first terminal and the second transmission information that is sent by the first terminal.

In some examples, the priorities are represented by the priority values, and the priority values are inversely proportional to the priorities.

In some examples, the first transmission information is sidelink potential conflict indication information sent by assisting UE to assisted UE in an inter-UE assistance mechanism. The sidelink potential conflict indication information indicates that a transmission resource of a second terminal is overlapped with a transmission resource of another terminal. A resource conflict is to occur at future Slot m.

In the inter-UE assistance mechanism of R17, the potential conflict indication is 1 bit, indicating whether there is a potential conflict. The potential conflict indication is sent by the assisting UE to the assisted UE, that is, sent by the first terminal to the second terminal, and is sent on the PSFCH of the first terminal. Through decoding a frequency-domain resource allocation information field and a time-domain resource allocation information field carried in SCI of the second terminal and another terminal, when the first terminal identifies that the second terminal and another terminal have reserved partially/fully overlapped resource at future Slot m, and an RSRP measurement value of a DMRS of the SCI for the partially/fully overlapped resource that is reserved by another terminal is greater than a RSRP threshold or greater than the RSRP measurement value of the DMRS of the SCI for the resource reserved by the second terminal, the first terminal determines that there is to be a potential resource conflict on the partially/fully overlapped resource at future Slot m. Therefore, the first terminal sends the potential conflict indication to the second terminal, and the second terminal performs a resource re-selection after receiving the potential conflict indication.

The second transmission information is sidelink HARQ feedback information.

It is to be noted that the division of the above functional modules is only used as an example for illustrating how to realize the functions of each apparatus provided in the above examples. In actual applications, the above functions may be assigned to different functional modules for implementation according to actual needs. That is, the internal structure of the apparatus may be divided into different functional modules to complete all or a part of the functions described above. In addition, the apparatuses provided by the above examples belong to the same concept as the method examples, whose specific implementation processes are detailed in the method examples and are not repeated here.

FIG. 8 illustrates a schematic structure diagram of a communication device provided by an example of the present disclosure. The communication device includes: a processor 801, a receiver 802, a transmitter 803, a memory 804 and a bus 805.

The processor 801 includes one or more processing cores, and the processor 801 performs various functional applications and information processing by running software programs and modules.

The receiver 802 and the transmitter 803 may be implemented as a communication component, which may be a communication chip.

The memory 804 is connected to the processor 801 through the bus 805.

The memory 804 may be configure to store at least one piece of program code, and the processor 801 is configured to execute the at least one piece of program code to implement each step in the above method examples.

Furthermore, the communication device may be a terminal. The memory 804 may be implemented by any type of volatile or nonvolatile storage device or a combination thereof, including but not limited to: a magnetic disk or optical disk, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

In an example, a computer-readable storage medium is also provided, in which executable program code is stored. The executable program code is loaded and executed by a processor to implement the information transmission method performed by a communication device provided by each of the above method examples.

In an example, a chip is provided. The chip includes a programmable logic circuit and/or program instructions. When running on a terminal, the chip is configured to implement the information transmission method provided in each of the method examples.

In an example, a computer program product is provided. When executed by a processor of a terminal, the computer program product is configured to implement the information transmission method provided by each of the above method examples.

Persons of ordinary skill in the art may understand that the implementation of all or part of the steps in the above examples may be accomplished by hardware or by instructing related hardware through a program. The program may be stored in a computer-readable storage medium. The above-mentioned storage medium may be a read-only memory, a disk or an optical disk, etc.

The above are only some alternative or additional examples of the present disclosure, and are not intended to limit the present disclosure. Any modifications, equivalent replacements, improvements, etc. made within the spirit and principles of the present disclosure shall be included in the protection scope of the present disclosure.

1. An information transmission method, performed by a first terminal, comprising:
performing a comparison of priorities of first transmission information, second transmission information and third transmission information in a case that a time-domain resource of the first transmission information, a time-domain resource of the second transmission information and a time-domain resource of the third transmission information are overlapped; and
transmitting, based on the comparison, one with a highest priority among the first transmission information, the second transmission information and the third transmission information;
wherein the first transmission information and the second transmission information are both carried on a physical sidelink feedback channel (PSFCH), and the third transmission information is transmission information other than transmission information carried on the PSFCH.

2. The method according to claim 1, wherein performing the comparison of the priorities of the first transmission information, the second transmission information and the third transmission information in the case that the time-domain resource of the first transmission information, the time-domain resource of the second transmission information and the time-domain resource of the third transmission information are overlapped comprises:
comparing the priorities of pieces of information transmitted on a same transmission channel firstly to determine one piece of transmission information with a higher priority in the case that the time-domain resource of the first transmission information, the time-domain resource of the second transmission information and the time-domain resource of the third transmission information are overlapped; and
comparing the one piece of transmission information with the higher priority with a piece of transmission information transmitted on a different transmission channel.

3. The method according to claim 1, wherein performing the comparison of the priorities of the first transmission information, the second transmission information and the third transmission information in the case that the time-domain resource of the first transmission information, the time-domain resource of the second transmission information and the time-domain resource of the third transmission information are overlapped comprises:
comparing the priorities of the first transmission information and the second transmission information transmitted on the PSFCH to determine one piece of transmission information with a higher priority in the case that the time-domain resource of the first transmission information, the time-domain resource of the second transmission information and the time-domain resource of the third transmission information are overlapped; and
comparing the one piece of transmission information with the higher priority with the third transmission information.

4. The method according to claim 1,
wherein performing the comparison of the priorities of the first transmission information, the second transmission information and the third transmission information in the case that the time-domain resource of the first transmission information, the time-domain resource of the second transmission information and the time-domain resource of the third transmission information are overlapped comprises:
sorting, according to the priorities, the first transmission information, the second transmission information and the third transmission information in the case that the time-domain resource of the first transmission information, the time-domain resource of the second transmission information and the time-domain resource of the third transmission information are overlapped; and
wherein transmitting, based on the comparison, the one with the highest priority among the first transmission information, the second transmission information and the third transmission information comprises:
transmitting, based on the sorting, the one with the highest priority among the first transmission information, the second transmission information and the third transmission information.

5. The method according to claim 1, wherein performing the comparison of the priorities of the first transmission information, the second transmission information and the third transmission information in the case that the time-domain resource of the first transmission information, the time-domain resource of the second transmission information and the time-domain resource of the third transmission information are overlapped comprises:
performing the comparison of the priorities of the first transmission information, the second transmission information and the third transmission information in a predetermined sequence in the case that the time-domain resource of the first transmission information, the time-domain resource of the second transmission information and the time-domain resource of the third transmission information are overlapped.

6. The method according to claim 1, further comprising:
transmitting other transmission information that is remaining in sequence according to the priorities; or
abandoning transmissions of other transmission information that is remaining.

7. (canceled)

8. The method according to claim 1, wherein the third transmission information comprises at least one of fourth transmission information carried on an uplink transmission channel or long-term evolution technology (LTE) sidelink transmission information.

9. The method according to claim 1, wherein the first transmission information comprises the first transmission information received by the first terminal and the first transmission information sent by the first terminal, and the second transmission information comprises the second transmission information received by the first terminal and the second transmission information sent by the first terminal.

10. The method according to claim 1, wherein the priorities are represented by priority values, and the priority values are inversely proportional to the priorities.

11. The method according to claim 1, wherein the first transmission information is sidelink potential conflict indication information indicating that a transmission resource of a second terminal is overlapped with a transmission resource of another terminal, and the second transmission information is sidelink hybrid automatic repeat request (HARQ) feedback information.

12.-22. (canceled)

23. A terminal, comprising:
a processor; and
a transceiver connected to the processor;
wherein the processor is configured to:
perform a comparison of priorities of first transmission information, second transmission information and third transmission information in a case that a time-domain resource of the first transmission information, a time-domain resource of the second transmission information and a time-domain resource of the third transmission information are overlapped; and
transmit, based on the comparison, one with a highest priority among the first transmission information, the second transmission information and the third transmission information;
wherein the first transmission information and the second transmission information are both carried on a physical sidelink feedback channel (PSFCH), and the third transmission information is transmission information other than transmission information carried on the PSFCH.

24. (canceled)

25. (canceled)

26. The terminal according to claim 23, wherein the processor is further configured to:
compare the priorities of pieces of information transmitted on a same transmission channel firstly to determine one piece of transmission information with a higher priority in the case that the time-domain resource of the first transmission information, the time-domain resource of the second transmission information and the time-domain resource of the third transmission information are overlapped; and
compare the one piece of transmission information with the higher priority with a piece of transmission information transmitted on a different transmission channel.

27. The terminal according to claim 23, wherein the processor is further configured to:
compare the priorities of the first transmission information and the second transmission information transmitted on the PSFCH to determine one piece of transmission information with a higher priority in the case that the time-domain resource of the first transmission information, the time-domain resource of the second transmission information and the time-domain resource of the third transmission information are overlapped; and
compare the one piece of transmission information with the higher priority with the third transmission information.

28. The terminal according to claim 23, wherein the processor is further configured to:
sort, according to the priorities, the first transmission information, the second transmission information and the third transmission information in the case that the time-domain resource of the first transmission information, the time-domain resource of the second transmission information and the time-domain resource of the third transmission information are overlapped; and
transmit, based on the sorting, the one with the highest priority among the first transmission information, the second transmission information and the third transmission information.

29. The terminal according to claim 23, wherein the processor is further configured to:
perform the comparison of the priorities of the first transmission information, the second transmission information and the third transmission information in a predetermined sequence in the case that the time-domain resource of the first transmission information, the time-domain resource of the second transmission information and the time-domain resource of the third transmission information are overlapped.

30. The terminal according to claim 23, wherein the processor is further configured to:
transmit other transmission information that is remaining in sequence according to the priorities; or
abandon transmissions of other transmission information that is remaining.

31. The terminal according to claim 23, wherein the third transmission information comprises at least one of fourth transmission information carried on an uplink transmission channel or long-term evolution technology (LTE) sidelink transmission information.

32. The terminal according to claim 23, wherein the first transmission information comprises the first transmission information received by the terminal and the first transmission information sent by the terminal, and the second transmission information comprises the second transmission information received by the terminal and the second transmission information sent by the terminal.

33. The terminal according to claim 23, wherein the priorities are represented by priority values, and the priority values are inversely proportional to the priorities.

34. The terminal according to claim 23, wherein the first transmission information is sidelink potential conflict indication information indicating that a transmission resource of a second terminal is overlapped with a transmission resource of another terminal, and the second transmission information is sidelink hybrid automatic repeat request (HARQ) feedback information.
